(19) United States
(12) Patent Application Publication
(10) Pub. No.: US 2026/0175465 A1
(43) Pub. Date: Jun. 25, 2026

(54) ADJUSTABLE PLANER

(71) Applicant: LAKEWOOD LIVE EDGE LLC, Lakewood, WA (US)

(72) Inventors: Micah B. GLASTETTER, Lakewood, WA (US); Matthew E. COUCH, Lakewood, WA (US)

(73) Assignee: LAKEWOOD LIVE EDGE LLC, Lakewood, WA (US)

(21) Appl. No.: 19/404,736

(22) Filed: Dec. 1, 2025

Related U.S. Application Data
(60) Provisional application No. 63/737,575, filed on Dec. 20, 2024.

(51) Int. Cl. B27C 1/02; B27C 1/14

(52) U.S. Cl. CPC B27C 1/02; B27C 1/14

(57) ABSTRACT

A planer for planing wood slabs. Large wood slab workpieces are planed by a heavy planer which includes a vertically stationary planer frame with drive wheels for horizontal movement along a pair of spaced apart rails, and a pivoting frame portion which is pivotably affixed to the stationary planer frame, for adjusting the depth of cut into a workpiece of a planer cutter head, which is rotatably mounted to the pivoting planer frame. An adjustable drive cylinder is used to adjust the pivoting planer frame and thereby adjust depth of cut. Workpiece clamps hold the workpiece in place. A leading-edge roller, a trailing edge roller, and airbags are used to provide downward pressure on a workpiece to secure it during operation. A control panel is provided for manipulation by an operator of range of variables, including depth of cut, or rate (horizontal movement) of cut.

### STATEMENT OF GOVERNMENT INTEREST

Not Applicable.

### COPYRIGHT RIGHTS IN THE DRAWING

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever.

### RELATED APPLICATIONS

This application claims priority from prior U.S. Provisional Patent Application Ser. No. 63/737,575, filed Dec. 20, 2024, entitled ADJUSTABLE PLANER, the disclosure of which is incorporated herein in its entirety, including the specification, drawing, and claims, by this reference.

### TECHNICAL FIELD

This disclosure relates to planers for smoothing wood, and particularly, planers configured for smoothing rough cut tree portions, such as slabs or other blanks, particularly as may be useful for the manufacture of live edge type furniture components, such as tops for tables and desks.

### BACKGROUND

A continuing need exists for improvements in planers, especially large planers which are capable of handling full-sized rough cut wood slabs such as are useful for creating large “live edge” type desks and tables, where the beauty of wood grain is revealed over a large slab of wood. In particular, it would be advantageous if a planer were available that was capable of efficiently planing slabs in a manner in which the completed planed wood surface then requires only a minimal amount of manual labor to prepare the wood surface for finishing, such as by application of various hard, clear, smooth coating materials as known by those of skill in the art. Moreover, it would be advantageous if such an improved planer were sized and shaped to handle “full-size” live edge slabs, as may occur naturally, such as up to as wide as five (5) or six (6) feet in width, and in the ten (10) foot to twenty (20) foot long range, or considerably longer. Commercially available planers are largely directed to configurations useful only on smaller width slabs, which often leaves a craftsman creating a table or desk with the requirement of piecing together multiple narrow width live edge slabs, rather than being about to use a single piece of already planed wood for incorporation into a finished desk or table.

Thus, there remains a continuing and as yet unmet need for (a) a planer which is useful for planing wood slabs to finish live edge wood pieces, and (b) a planer which is capable of handling wood slabs of oversize width and length, such in the three (3) foot to six (6) foot range in width. And, it would be desirable to have a planer which is capable of moving over a stationary workpiece, with working lengths in the ten (10) feet to twenty (20) feet of planer travel, or even longer. As well, the provision of a solid, smooth surface (e.g. rails) for translation of the planer in a steady manner while planing across a wood workpiece would be even more advantageous.

### Some Objects, Advantages, and Novel Features

Accordingly, one objective of the invention(s) disclosed herein is to provide a design for a planer in which the weight and rigidity of the structure, including the frame components, enable the planer to remain unaffected by differing densities workpieces being planed, such as wood knots and the like.

In an embodiment, another objective is to provide a design for a planer which can be moved, when necessary, on a trailer having rails thereon.

Another important objective is to provide a planer that is adaptable to working large wood slabs, especially those in the range of up to the range of between five (5) to six (6) feet in width, and in the range of between ten (10) foot and twenty (20) foot in length, or even considerably longer, so that a single planed slab may be used to create furniture portions such as the working surface of a table or desk, without the necessity to glue multiple smaller width pieces together.

Another objective is to provide a planer where the workpiece remains stationary while the planer head moves over the workpiece, which results in reducing the overall length of workspace necessary by half, compared to planers which are configured to be stationary, while receiving a moving workpiece. This is particularly advantageous when planing a long workpiece slab, such as a twenty (20) foot long slab.

Another objective is to complete the planing of a workpiece slab in a single pass. This reduces time required to complete a finished workpiece, especially when compared to conventional CNC type machine, which can typically only flatten (plane) a workpiece along a narrow strip, such as about three and a half inches (3.5″), which requires multiple time-consuming passes on a wide workpiece. As well, a related benefit is that because router type bits used in CNC equipment spin, burn marks are often created when using such equipment to plane a workpiece, which results in even more work to sand out the burn marks. In some cases, such spinning motion even results in tear-out of wood grain. It is an advantage that burn marks and wood grain tear-out are completely avoided when using an adjustable planer design as taught herein. Further, the planer described herein avoids issues related to tramming which may be experienced in CNC type machines, when a spindle is not perfectly perpendicular to the work surface in both the X (i.e. horizontal along the length of the workpiece] and Y (i.e. vertical) axes, and as a result, an uneven surface with ridges is created as a byproduct, and which requires considerable sanding to remove.

A related objective is to provide a planer which efficiently gathers up chips and dust from the planing process, and which allows for continuous collection, and ultimate discharge when and as appropriate of the accumulated sawdust and chips. In this regard, an important aspect of the invention described herein is the “on-board” sawdust and chip collection system, which eliminates the necessity to rely on stand alone, separate dust collection systems. In an embodiment, a fully automated chip collection system may be provided, using a screw conveyor and a rotary air lock.

Another objective is to provide an easily controlled feed rate for a planer which can be reliably moved across a workpiece at a selected rate, utilizing a solid smooth support system such as rails, in order to assure smoothness and uniformity in a finished wood workpiece. It is an advantage that the controllable feed rate of the planer described herein allows adjustment to different wood densities and depth of cuts, to ensure uniformity and smoothness of the finished workpiece.

Finally, another objective is to provide a high-quality planer capable of finishing wide and long wood workpieces to provide a uniform finished wood surface, so that manufacturing costs for finished tables and desks are minimized.

### SUMMARY

We have now developed a novel planer apparatus for planing a face of a wood workpiece, and more specifically, for planing large wood slabs which may be useful in the fabrication of desks and tables which include a “live edge” surface. In an embodiment, the planer includes (a) a stationary planer frame which includes drive wheels for movement along a pair of spaced apart rails, and (b) a pivoting planer frame which is pivotally mounted to the stationary frame. A planer cutter head is rotatably mounted to the pivoting planer frame. An adjustable drive may be utilized to adjust the angle of the pivoting planer frame with respect to the stationary frame. In an embodiment, adjustment of the angle between the stationary planer frame and pivoting planer frame may be provided in the form of a frame adjustment cylinder having an adjustable piston. Movement of the pivoting planer frame provides for movement of the planer cutter head downward toward or upward away from a wood workpiece affixed there below. In an embodiment, workpiece clamps may be utilized to fix a location for a wood workpiece on a platen located between the spaced apart rails. In an embodiment, the planer cutter head and the drive wheels may be electrically powered. In an embodiment, a leading-edge roller may be provided to provide downward pressure on a workpiece, so as to assist in maintaining a firm and secure position of the workpiece. In an embodiment, a trailing edge roller may be provided to provide downward pressure on a workpiece, so as to assist in maintaining a firm and secure position of the workpiece. In an embodiment, an airbag system may be utilized for uniform pressure distribution on the leading edge roller, or trailing edge roller, or both. A control panel may be provided for manipulation by an operator of range of variables, such as depth of cut, or rate (horizontal movement) of cut. For ease in observing the planing operation, the control panel may be mounted to the stationary frame, and be pivotable outward therefrom.

In an embodiment, the stationary frame may include a first base member and a second base member which are spaced apart, with each having a front end and a rear end. A first front post and a second front post may be provided, each of which have a bottom and a top. In an embodiment, the bottom of the first front post may be affixed at or near the front end of the first base member, and extend upward therefrom. In an embodiment, the bottom of the second front post maybe affixed at or near the front end of the second base member, and extend upward therefrom. A first rear post and a second rear post may be provided, with each having a bottom and a top. In an embodiment, the bottom of the first rear post may be affixed at or near the rear end of the first base member. Likewise, the bottom of the second rear post may be affixed at or near the rear end of the second base member. The stationary frame may also include a front cross bar. In an embodiment, the front cross bar may be oriented orthogonally to the first base member and to the second base member. In an embodiment, the front cross bar may be secured to the first front post and to the second front post. A first pivot mount and a second pivot mount may be provided, where the first and second pivot mounts are spaced apart, with each pivot mount affixed to the front cross bar. A pivot pin sized and shaped for cooperative pivoting action with the pivoting planar frame may be provided with each of the first and second pivot mounts. In an embodiment, for adjustably securing a frame adjustment cylinder, as well as providing rigidity to the stationary frame, an upper rear cross member may be provided. In an embodiment, the upper rear cross member may be oriented orthogonally to the first base member and to the second base member, and secured to the first rear post and to the second rear post. Optionally, a lower rear cross member may be provided in the stationary frame. In such an embodiment, the lower rear cross member may be oriented orthogonally to the first base member and to the second base member, with the lower rear cross member secured to and between the first rear post and the second rear post.

In an embodiment, a pivoting planer frame may include a first longitudinal planer frame member and a second longitudinal planer frame member, each having a front end and a rear end. A first rear planer frame cross member may be mounted between the first longitudinal planer frame member and the second longitudinal planer frame member, at a location at or near the rear end of each. Importantly, a front planer frame cross member is provided where the front planer frame cross member is mounted between the first longitudinal planer frame member and the second longitudinal planer frame member, at or near the front end of each. A first pivot receiver and a second pivot receiver are mounted to the front planer frame member, at locations and sized and shaped for cooperation with the pivot pins located in the first pivot mount and the second pivot mount. Thus, a pivoting planer frame is secured for pivotal movement with respect to the stationary frame.

An adjustable drive is provided for increasing or decreasing the angle between the stationary frame and the pivoting planar frame. In an embodiment, the adjustable drive may be provided in the form of a frame adjustment cylinder which includes a drive motor, a mount secured to the upper rear cross member of the stationary frame, a cylinder barrel, and adjustable piston. In an embodiment, the adjustable piston may include a distal end which is pivotally secured to a first rear planer frame cross member. The frame adjustment cylinder is configured to effect movement between the stationary frame and the pivoting planer frame.

A planer cutter head is rotatably mounted to the pivoting planer frame. The height of the planer cutter head above the wood workpiece, which is directly related to the depth of engagement of the planer cutter head with the wood workpiece, is adjustable by operation of the frame adjustment cylinder. In this manner, the planer cutter head may be adjustably engaged with or disengaged from the wood workpiece.

### BRIEF DESCRIPTION OF THE DRAWING

The present invention(s) will be described by way of exemplary embodiments, using for illustration the accompanying drawing figures in which like reference numerals denote like elements, and in which:

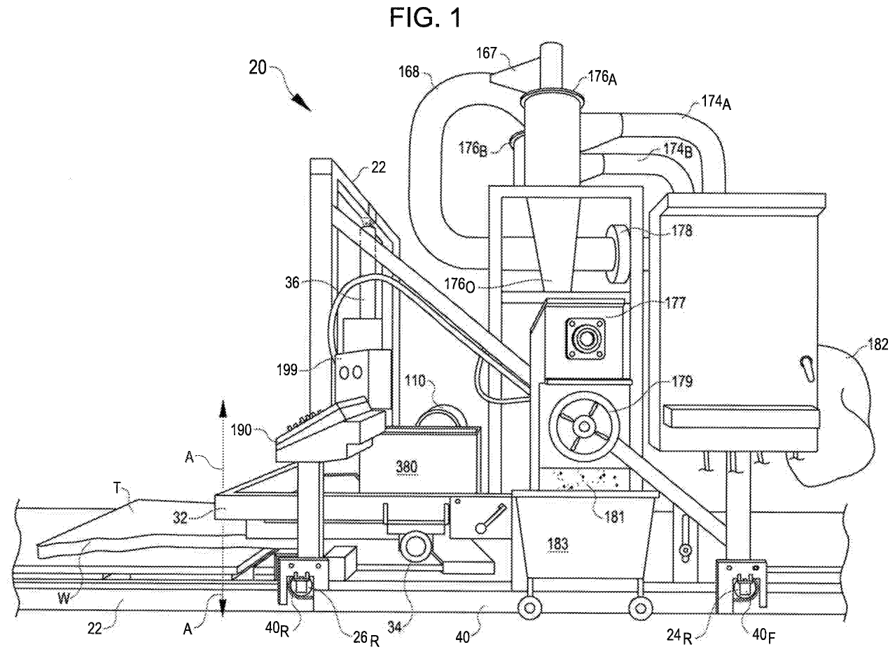

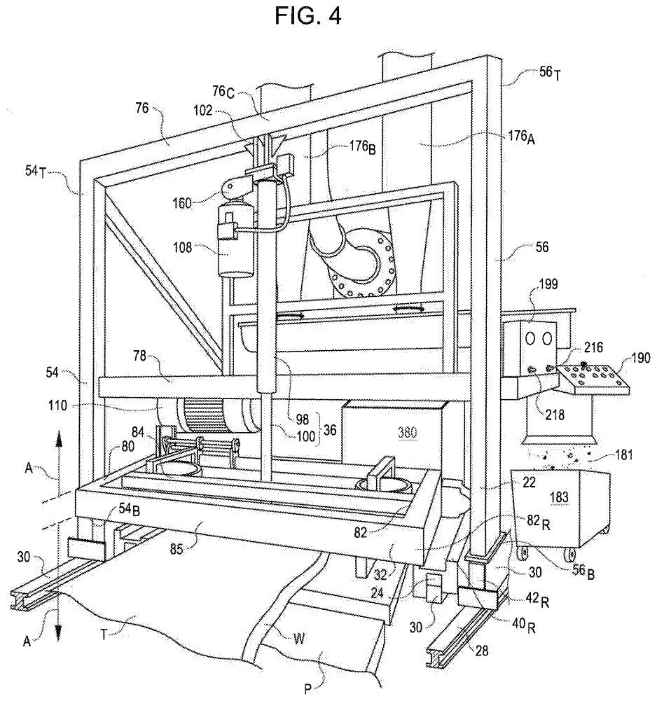

FIG. 1 provides a side perspective view which illustrates some of the exemplary components for an embodiment of a planer apparatus, showing a vertically stationary frame which includes drive wheels for horizontal movement along a pair of spaced apart rails (see FIGS. 4, 5, 11, and 14) and a pivoting planer frame which is pivotally mounted to the stationary frame. A planer cutter head is rotatably mounted to the pivoting planer frame, and chip handing and collection equipment, including a cyclone separator for separating chips and sending them downward to a horizontal rotary screw conveyor, and downward through a rotary air lock through which collected chips are periodically released into a chip collection/transfer basket.

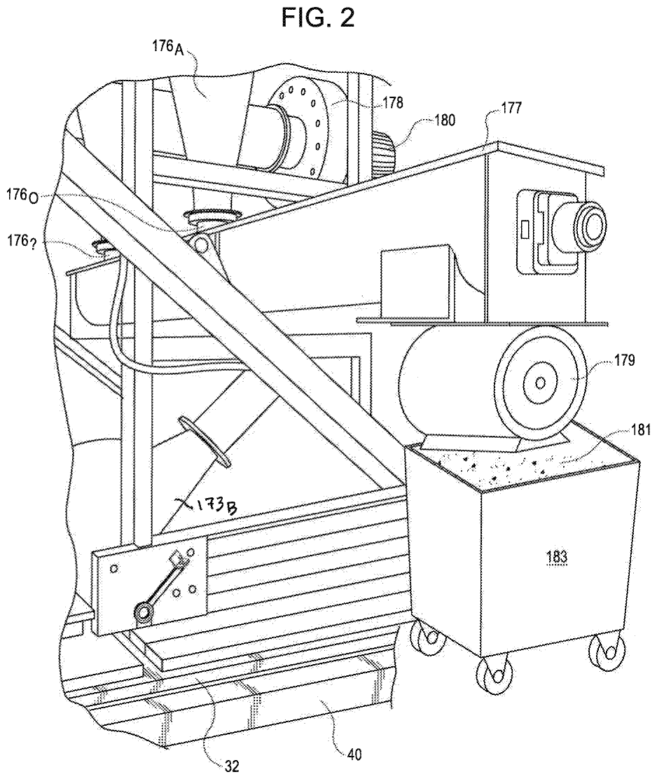

FIG. 2 is a side perspective view of an embodiment of a planer apparatus, showing additional details for discharge of chips from a cyclone separator used for separating chips from sawdust, and sending the chips downward to a horizontal rotary screw conveyor, and a rotary air lock through which collected chips are periodically released into a chip collection/transfer basket.

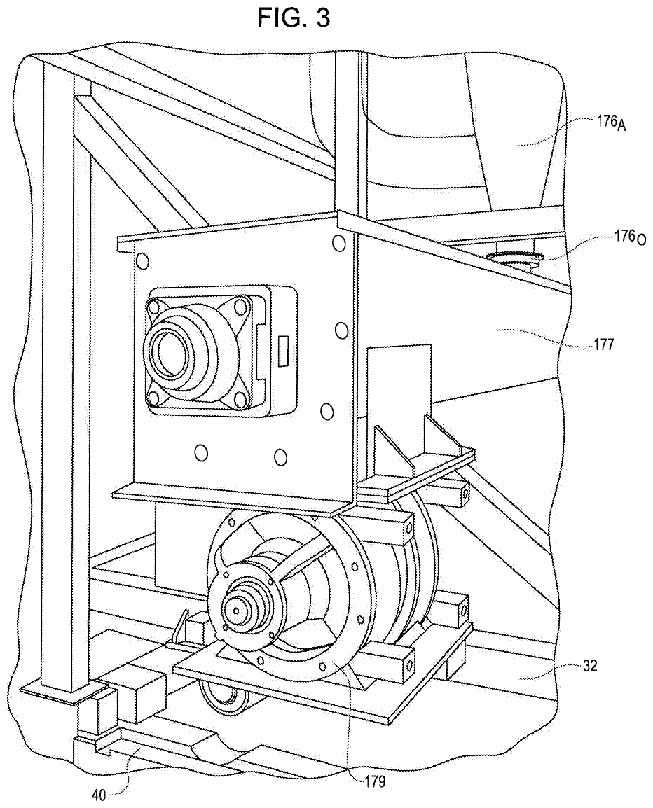

FIG. 3 is similar to FIG. 2, but provides a different side perspective view of an embodiment of a planer apparatus, showing additional details of an embodiment for including a cyclone separator for separating chips and sending them downward to a horizontal rotary screw conveyor, and a rotary air lock through which collected chips are periodically released into a chip collection/transfer basket (see FIG. 1) from the horizontal rotary screw conveyor.

FIG. 4 is rear perspective view for an embodiment of a planer apparatus, showing a stationary frame which includes drive wheels for horizontal movement of the stationary frame along a pair of spaced apart rails, and a pivoting planer frame which is pivotally mounted for substantially vertical movement with respect to the stationary frame, and chip handing and collection equipment, including a pair of cyclone separators for separating chips and sending them downward to a horizontal rotary screw conveyor, a control panel, and controls for adjustment of downward pressure on a leading roller and on a trailing roller, which are further described below, and a weight box laterally across from the motor, and in which an effective selection of weights (comparable by location and lateral moment) may be placed to offset and balance the weight of the planer cutter head drive motor and its related mount and drive, in order to maintain a level planing surface across the width of a workpiece.

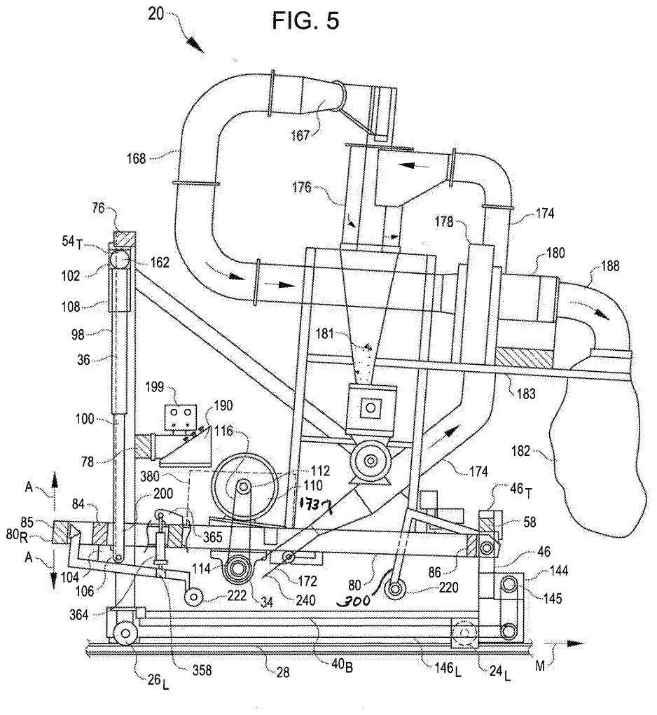

FIG. 5 is a side view of a conceptual design layout for an embodiment of a planer apparatus, showing a vertically stationary frame with chain driven wheels for driving the apparatus horizontally along a pair of rails (only one rail shown), a pivoting planer frame, and planer cutter head rotatably mounted to the pivoting planer frame, and an extensible frame adjustment cylinder, to adjust the height of the pivoting planer frame within the stationary frame, and with respect to a wood workpiece and thus as regards the height above, or depth of cut into, a wood workpiece. Also shown is a leading roller for application of rolling pressure downward on a workpiece ahead of planer cutter head, and a trailing roller for application of rolling pressure downward on a workpiece behind, but adjacent the planer cutter head. Additionally, a horizontally extending chip capture blade is provided, and which is a wear part configured for resting on and traveling along a workpiece during forward motion of the planar apparatus to capture and direct sawdust and chips into a collection and separation system. In that system, chips are separated from sawdust at one or more cyclone separators, and collected and accumulated in a screw conveyor and ultimately discharged at a rotary air lock. The airstream containing sawdust is discharged into a sawdust baghouse which includes a filter bag for collection of sawdust, all of which maximizes chip and sawdust collection.

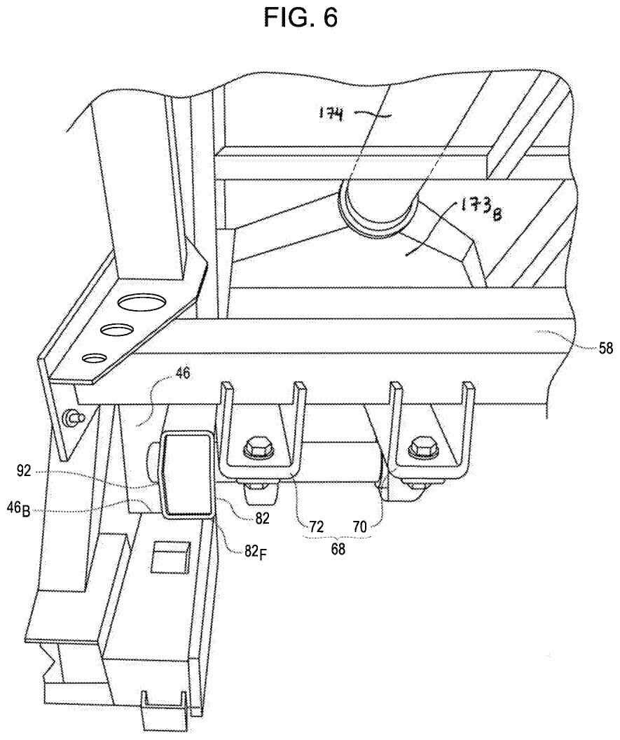

FIG. 6 provides a partial front perspective view, showing an embodiment for portions of a pivoting connection at the front of the planer apparatus, showing a front cross bar on the stationary frame, a first pivot mount including a first pivot mount bracket and a second pivot mount bracket, with a first pivot pin pivotally connecting the first pivot mount to the first longitudinal frame member of the pivoting planer frame.

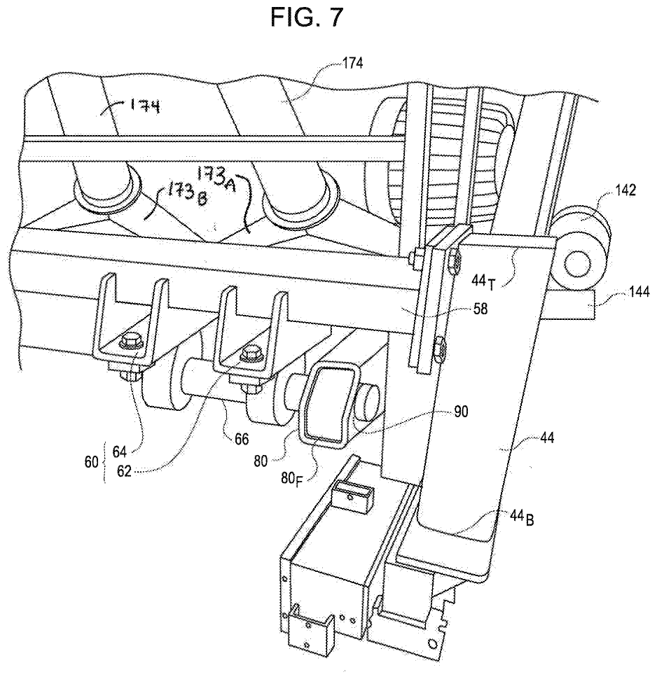

FIG. 7 provides a partial perspective view looking back at the front of the planer apparatus, showing a front cross bar on the stationary frame, a second pivot mount including a third pivot mount bracket and a fourth pivot mount bracket, with a second pivot pin pivotally connecting the first pivot mount to the second longitudinal frame member of the pivoting planer frame, and also showing at the edge, the location for a wheel drive motor and gear box for a rail wheel drive system.

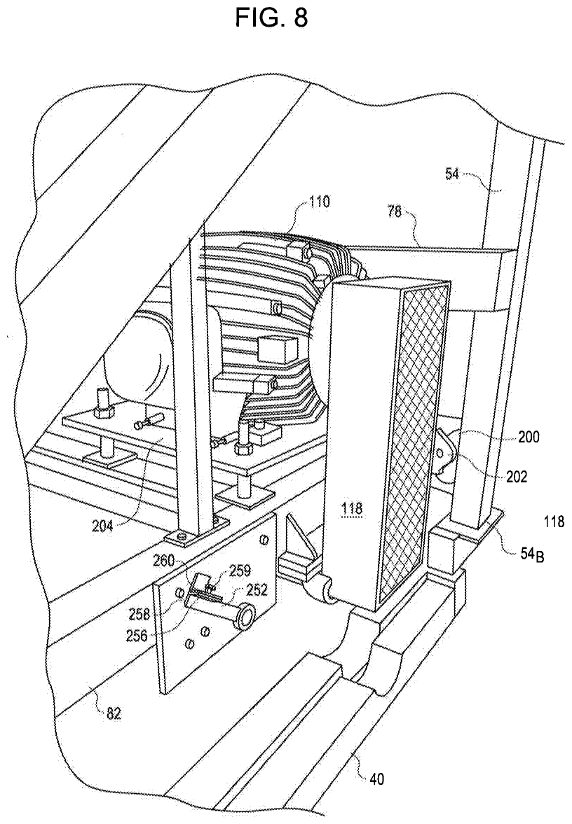

FIG. 8 provides a partial perspective view of the left side of the planer apparatus, looking rearward, showing the planer cutter head drive motor for the planer cutter head, and a safety cage covering the motor pulley, cutter pulley, and planer cutter drive belt, all mounted on or to the pivoting planer frame.

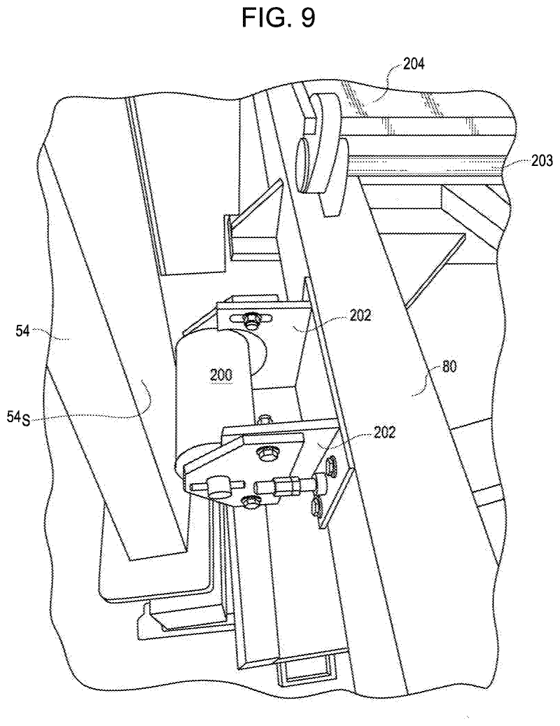

FIG. 9 provides a partial top perspective view, looking down from the left rear, looking forward at a positioning roller used for maintaining the spaced relationship between a substantially horizontal pivoting planer frame member and a vertically upwardly extending first rear post of the stationary frame, as well as showing a pivoting mount for the drive motor for the planer cutter head.

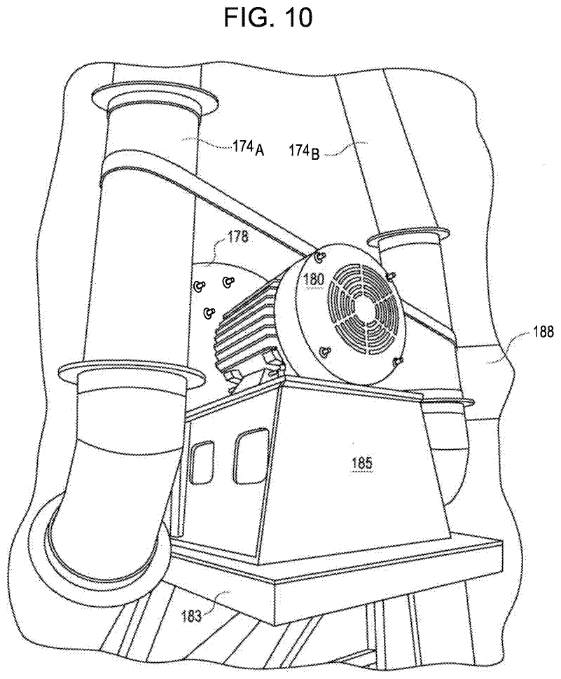

FIG. 10 provides a partial perspective view of a portion of the ducting which contains for transport an air exhaust stream that carries chips and sawdust from collectors (not shown in FIG. 10) which are located adjacent the chip capture blade bear near the rotary cutter head (also not shown in this FIG. 10), here showing the upward configuration of the ducts toward the cyclone chip separators (see FIG. 1), and also shows the chip collection exhaust blower and the associated blower motor; this configuration enables air, sawdust, and chips through the cyclone system, and sends the sawdust outward to a baghouse where sawdust is collected.

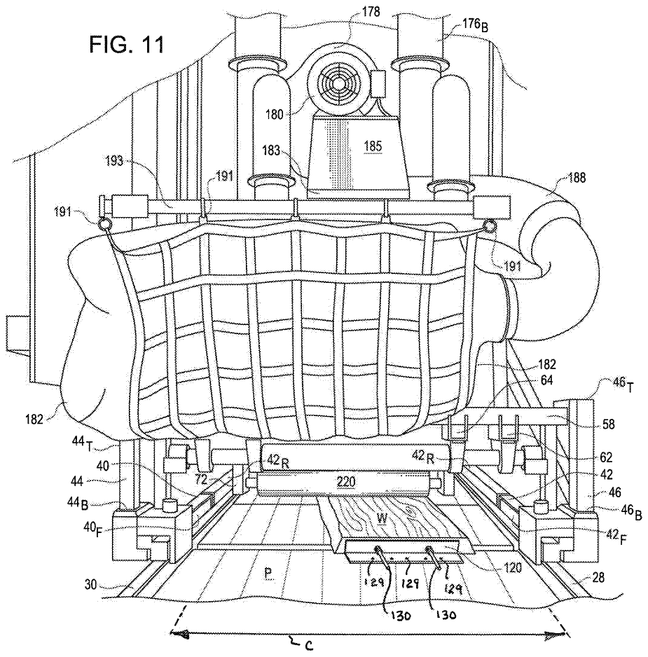

FIG. 11 is a rear perspective view, showing the blower motor for the chip collection exhaust blower that pulls air and sawdust through the cyclone system and sends the sawdust outward to a baghouse which collects the sawdust, and shows a baghouse as deployed during operation; additionally, a wood workpiece W is shown secured by wood screws to a platen between spaced apart left and right rails on which the planer apparatus travels during operation, and also shows a workpiece W secured by a workpiece clamp on a platen between the rails.

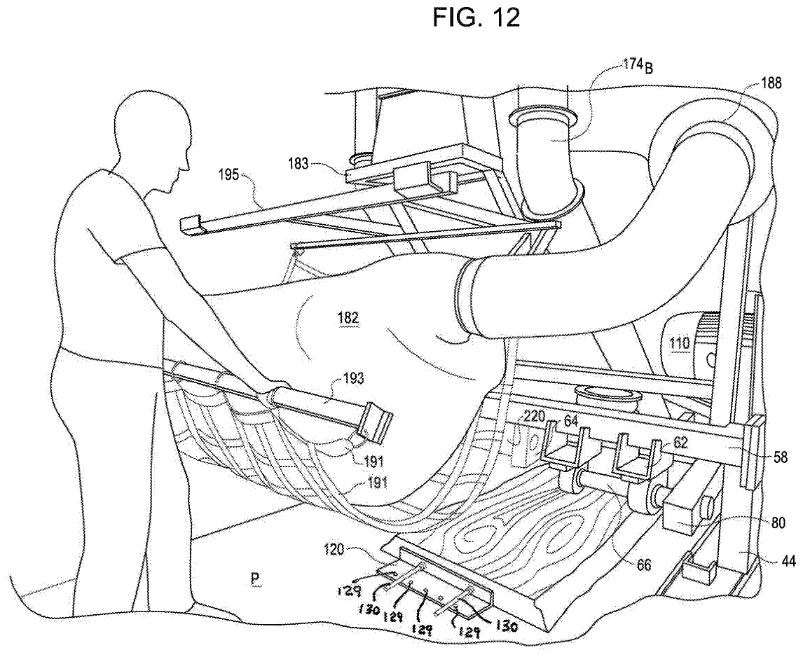

FIG. 12 is similar to FIG. 11, and provides a partial rear perspective view, showing the baghouse being released from its operational position, via decoupling of its containment webbing from the baghouse frame, with the baghouse being released for cleaning.

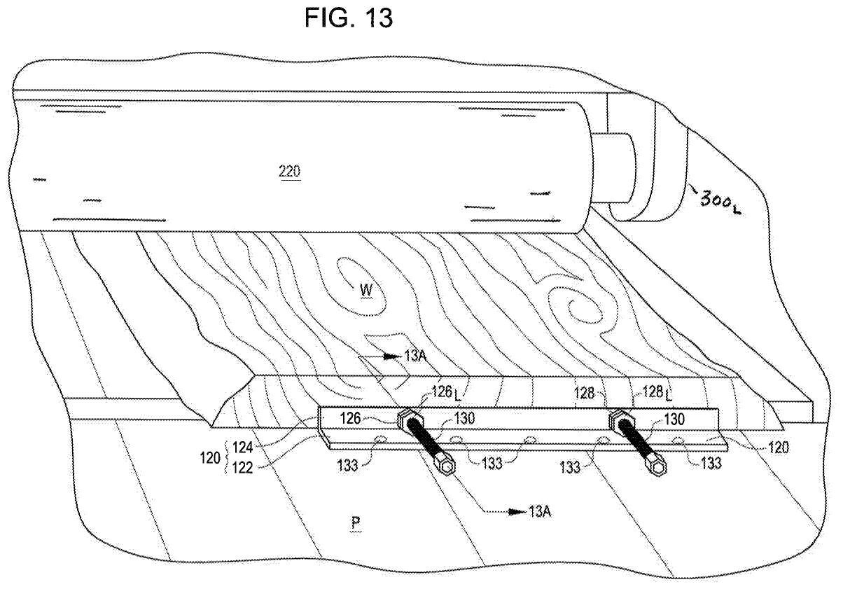

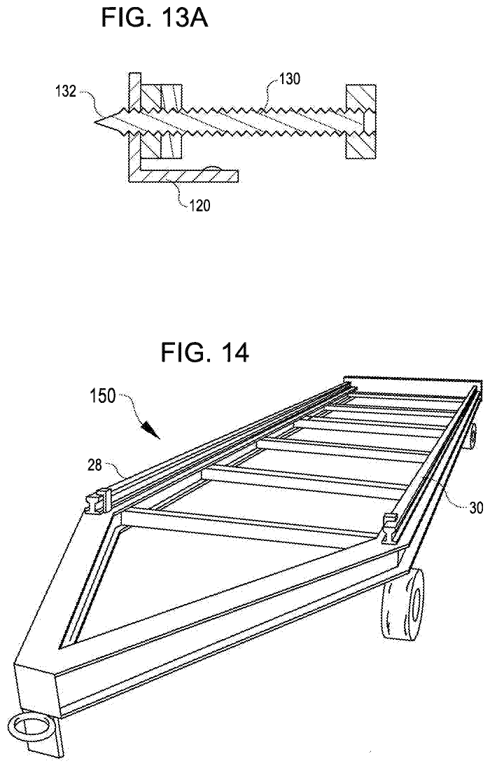

FIG. 13 is a partial front perspective view, looking rearward, for an embodiment of a planer apparatus, showing a platen on which a wood workpiece W is being secured using a workpiece clamp, and a leading roller for application of pressure vertically downward on the workpiece W.

FIG. 13A is a cross-sectional view along line 13A-13-A of FIG. 13, showing the configuration for a threaded bolt which is mounted via threaded connection to an angle iron used for a workpiece clamp, and shows the distal end of the threaded bolt in a conical configuration, where the apex of the distal end is shaped to penetrate and secure the wood workpiece in place.

FIG. 14 is a perspective view of a trailer with parallel rails, on which a planar apparatus can be secured for transport.

FIG. 15 provides a partial perspective view of the interior of the front of an embodiment of a planer apparatus, wherein one side of the support structure for the leading roller is depicted, adjacent the chip and sawdust collection system, near the rotary cutter head (not shown), and also showing an embodiment for location and use of one of a plurality of leading airbags for application of pressure across the width of the leading roller, and thus across the width of a workpiece.

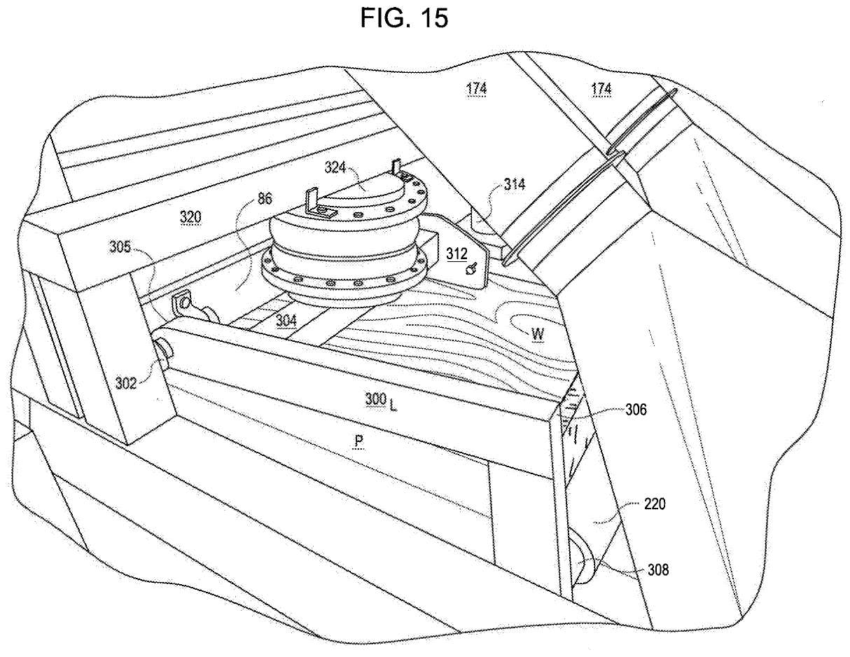

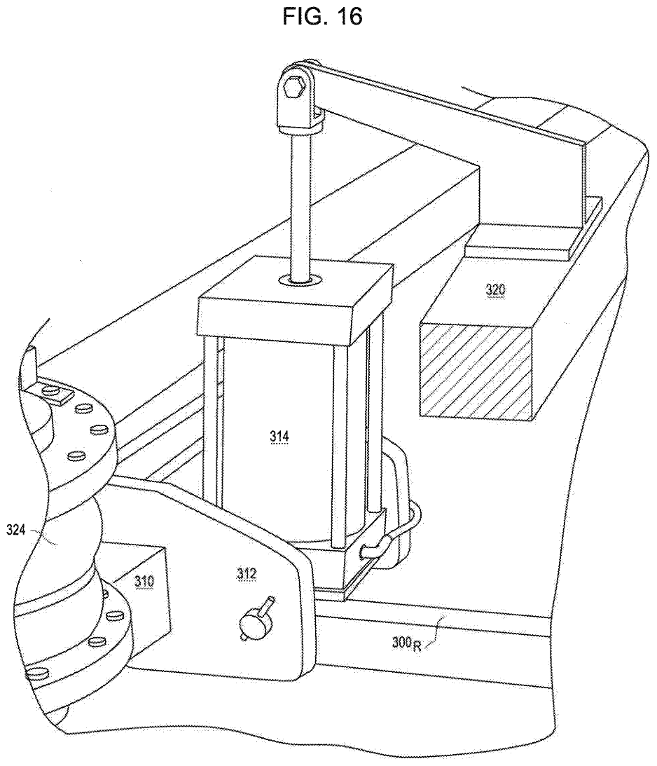

FIG. 16 is a close up of a portion of FIG. 15, and provides a perspective view for an embodiment for mounting and actuating the lead actuator which is used to raise or lower the leading roller, by acting on the leading roller supporting structure, and which is used in combination with the leading airbags for adjustably controlling downward pressure on the leading roller.

FIG. 17 is a view of apparatus initially shown in FIGS. 15 and 16 above, and provides a front perspective view of an embodiment for the support structure for a lead actuator which may be used to raise the leading roller by acting on the leading roller supporting structure which may be used in combination with the plurality of lead airbags, now shown as mounted for operation, all for adjustably controlling downward pressure on the leading roller, so that the leading roller can apply pressure on a workpiece slab to secure the slab in place while being worked.

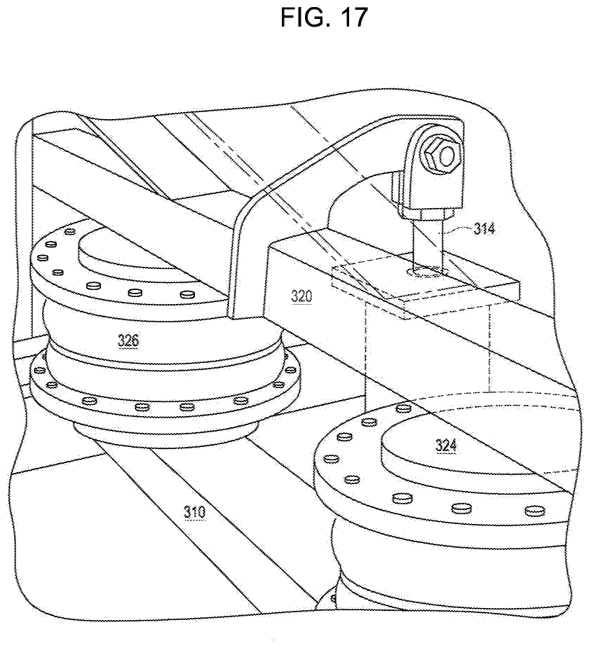

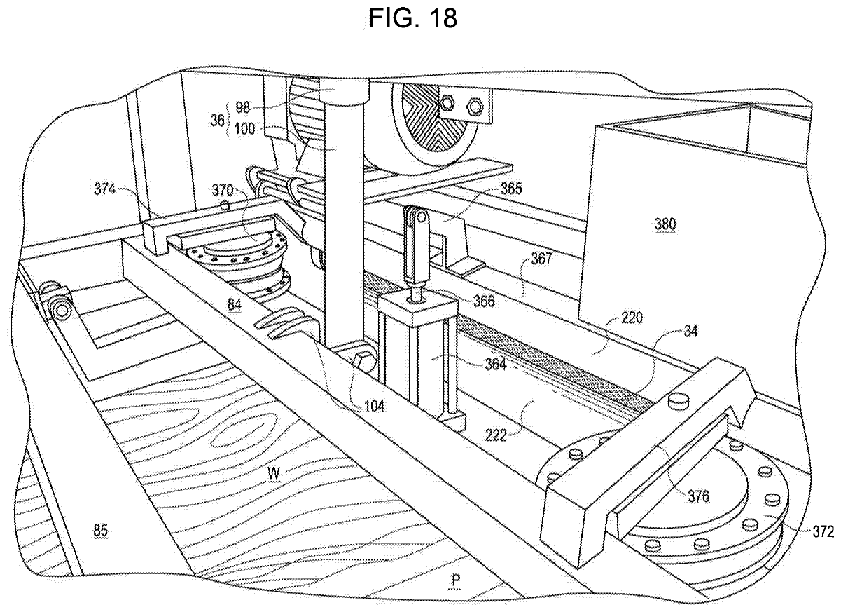

FIGS. 18 through 23 provide details of various elements for mounting and operation of the trailing roller.

FIG. 18 provides a partial perspective view of the trailing roller, showing it mounted adjacent the rotary cutter. The mounting details of the trailing airbags used for controlling pressure of the trailing roller against a workpiece are shown, as well as a trail actuator which is used for downward extension and upward retraction of the trailing roller. A frame adjustment cylinder is pivotally mounted between the pivoting planer frame and the stationary planer frame (not shown) for effecting movement of the pivoting planer frame—upward or downward—with respect to the stationary planer frame. The trailing roller is positioned to apply pressure to a workpiece to secure the workpiece in place during planing operation.

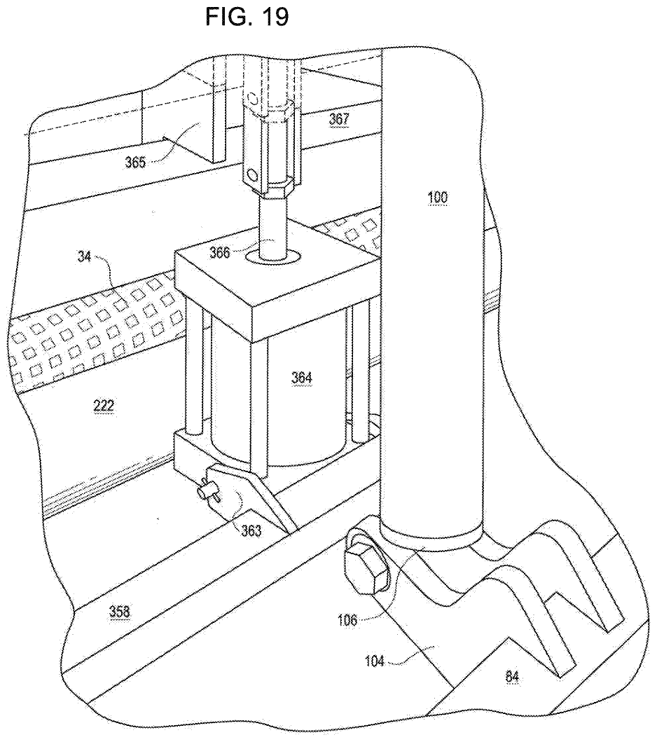

FIG. 19 shows a pivot mount for the frame adjustment cylinder, which provides height adjustment for the pivoting planer frame—upward or downward—with respect to the stationary planer frame (not shown, see FIG. 5). FIG. 19 also reveals the location of a trail actuator which is used for retracting the trailing roller from a workpiece, or lowering the trailing roller to a workpiece. When the trailing roller is in the downward, operating position, adjacent the cutter head, airbags (see FIGS. 18 and 20) are used to apply pressure to a workpiece.

FIG. 20 provides a detail of an embodiment for mounting a trailing airbag, in the configuration first shown in FIG. 18, and shows an embodiment for mounting the top of an airbag in the plurality of airbags which are used for application of downward pressure by the trailing roller against a workpiece, and wherein the trailing roller is seen, and which is suspension arms which are moved upward or downward by the trail actuator, and which are moved by pneumatic pressure in the plurality of trail airbags to apply pressure across the trail roller.

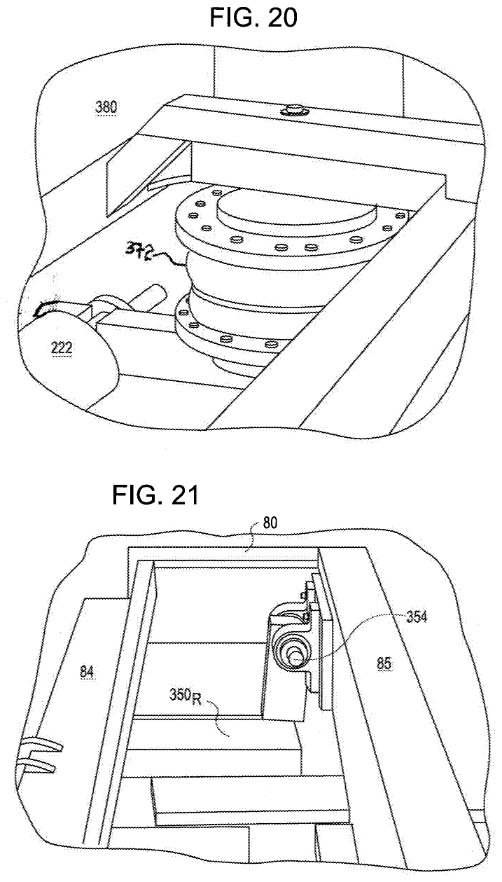

FIG. 21 provides further details for a mirror image of the configuration first seen in FIG. 18, and illustrates an embodiment for first, right side pivot mount for an actuating arm on which the trailing roller is mounted.

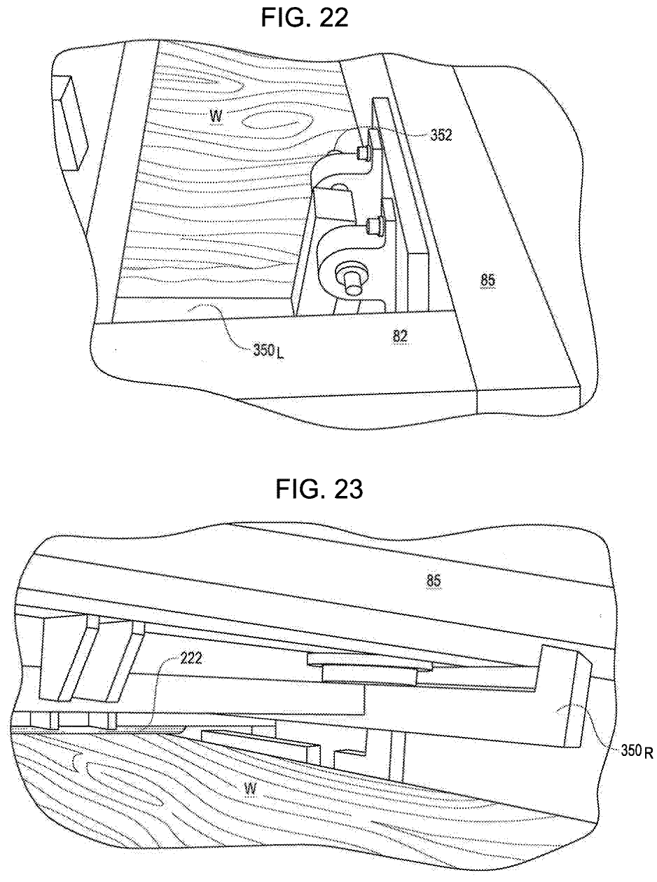

FIG. 22 further illustrates the mounting configuration for a second, left side pivot mount for an actuating arm on which the trailing roller is mounted.

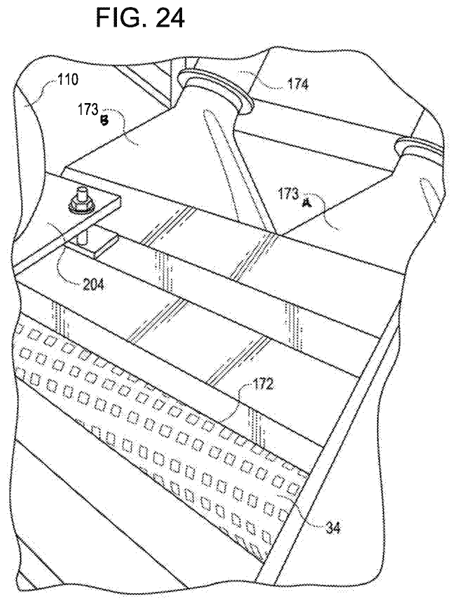

FIG. 23 is a perspective view from the lower rear, looking forward, showing an actuating arm on which the trailing roller is mounted, and showing the trailing roller acting on a workpiece.

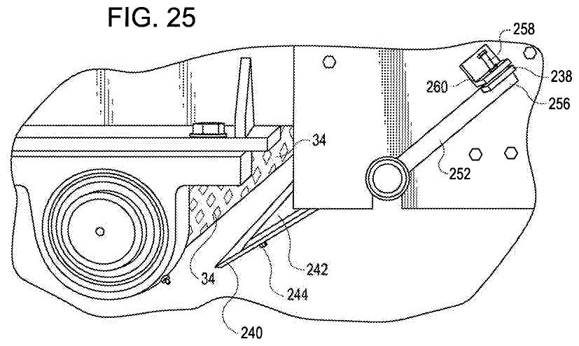

FIGS. 24 and 25 provide details of portions of the sawdust and chip collection system, including a chip capture blade which is a replaceable wear piece which is placed in contact with the workpiece, so as to maximize sawdust and chip protection, as well as intake ducts for sawdust and wood chips.

FIG. 24 shows details for an embodiment of an adjustable planer, showing locations for intake ducts for sawdust and wood chips, and their proximity to the rotary cutter head.

FIG. 25 provides a side perspective view of a rotary cutter head, and adjacent chip capture blade, showing a chip capture blade support on which the chip capture blade may be mounted for use, using suitable fasteners, and with respect to which a new chip capture blade may be mounted after usage of the adjustable planer results in end-of-life wear on the chip capture blade. Additionally, an adjustment mechanism is shown that provides for setup and adjustment of the angle of the chip capture blade, so that it can be suitably positioned against a workpiece.

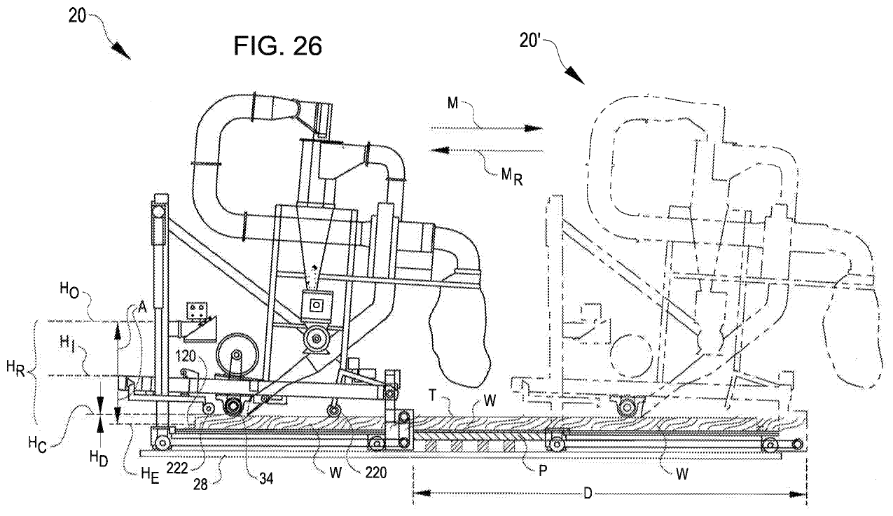

FIG. 26 provides a schematic view depicting the advancement of an embodiment for an adjustable planer along rails, over a stationary workpiece affixed to a platen; although only a single planer is actually utilized, the repetition (showing a second planer in broken lines in a second location, in order to show a starting location and a finish location.

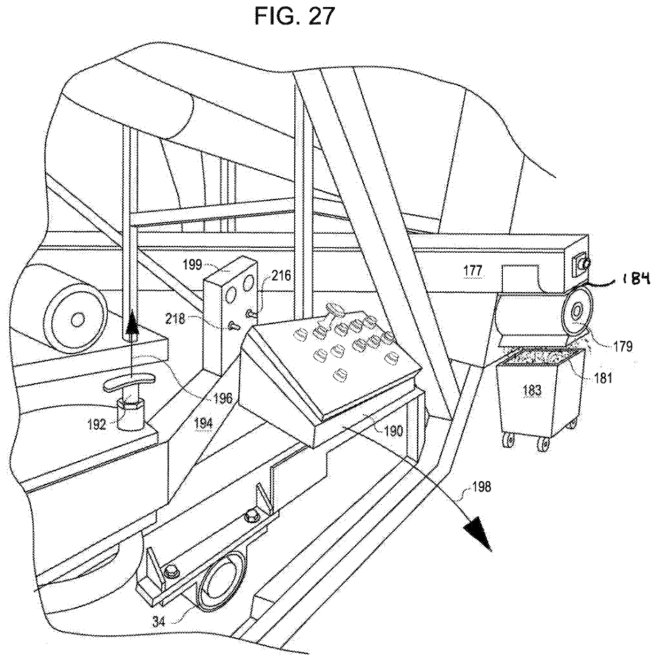

FIG. 27 provides location and functional details for a pivotably mounted control panel for the adjustable planer, and also illustrates further details of a control panel for adjustment of pressure on a trailing roller and on a leading roller, as well as controls for operation of the vertical position of the adjustable frame portion, and for other components, including the rotary cutter, drive wheels, and chip/sawdust blower.

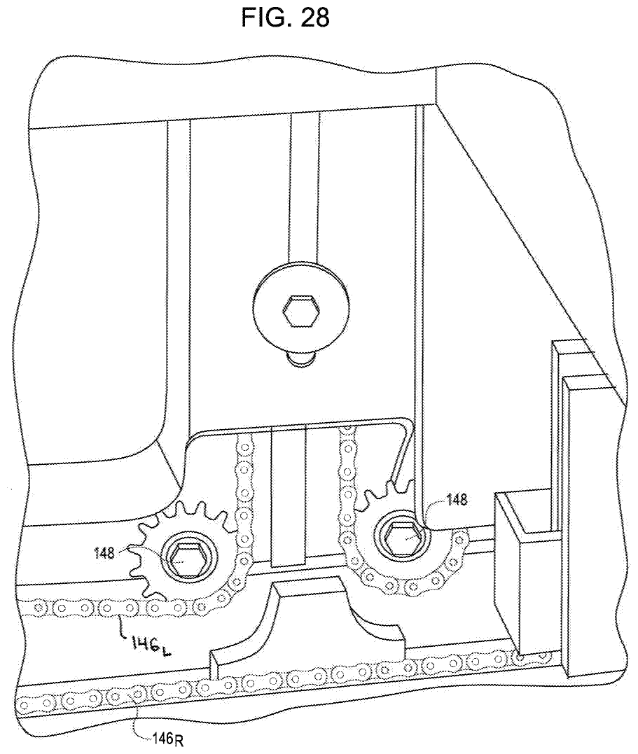

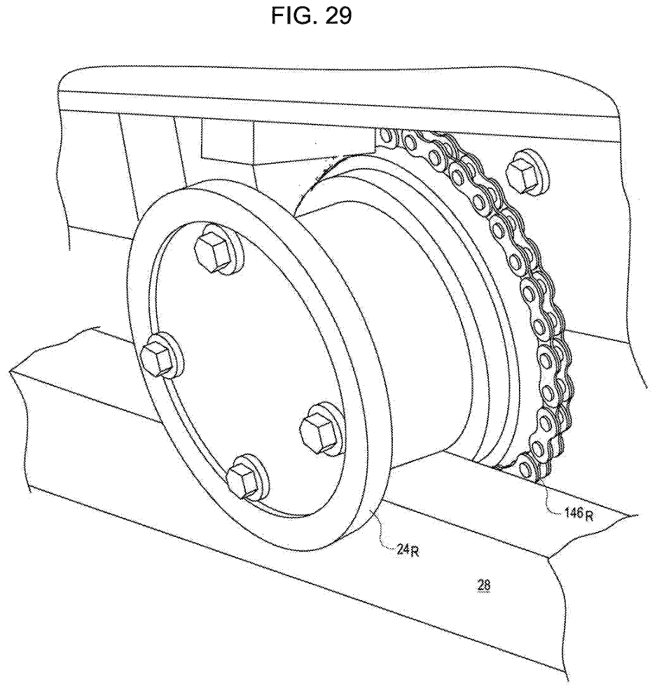

FIG. 28 provides an embodiment for coupling and gear arrangement to direct the output of a chain drive shaft to a first drive chain, wherein the first drive chain is operatively coupled to a first driven wheel and to a second driven wheel; similar operation may be provided (not shown) for a coupling and gear arrangement to direct the output of a chain drive shaft to a second drive chain, wherein the second drive chain is operatively coupled to a third driven wheel and to a fourth driven wheel.

FIG. 29 illustrates an embodiment for a wheel which is driven by chain drive, and where the driven wheel is sized and shaped for rolling engagement with one of the rails in a pair of parallel support rails, as seen in FIG. 5 or 11 as described herein.

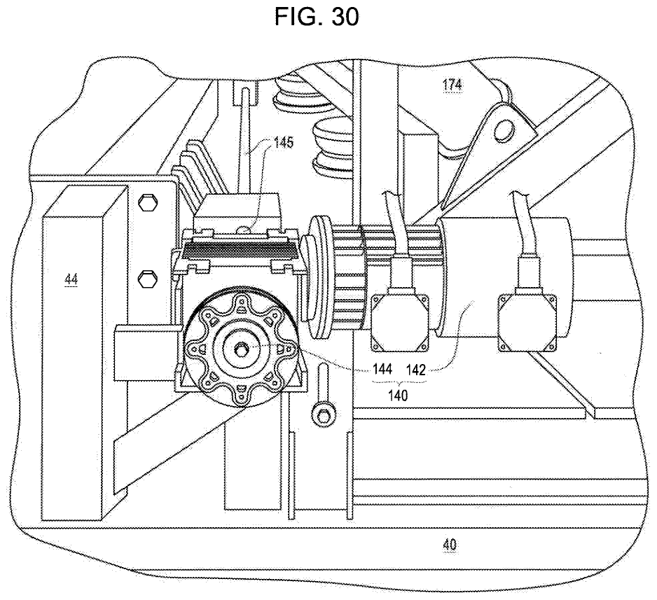

FIG. 30 provides a perspective view looking at the left side (as oriented when facing forward, which is the direction of movement during planing) of a portion of the left side of the planer apparatus) showing a front post, and an electric wheel drive motor and accompanying gearbox for powering the chain drive shaft which extends from the gearbox.

The foregoing figures, being merely exemplary, contain various elements that may be present or omitted from a final configuration for an embodiment of a planer apparatus for planing of wood workpieces. Other variations may use slightly different mechanical structures, mechanical arrangements, or size and shape of components, and yet employ the principles described herein and as generally depicted in the drawing figures provided, and as more specifically called out in the claims set forth below. An attempt has been made to draw the figures in a way that illustrates at least those elements that are significant for an understanding of an exemplary adjustable planer apparatus, and suggestive embodiments for use of such a planer apparatus to smooth rough wood blanks as maybe useful for creating “live edge” desks and tables using wide wood workpieces.

It should be understood that various features may be utilized in accord with the teachings hereof, as may be useful in different embodiments as useful for various sizes and shapes of adjustable planer machines, and related drive systems and sawdust and chip collection systems, and control systems therefore, depending upon the specific requirements (such as typical width requirements for wood workpieces used to form tables and desks) within the scope and coverage of the teachings herein as defined by the claims. Further, like features in various embodiments for various components for an adjustable planer apparatus may be described using like reference numerals, or other like references, without further mention thereof.

### DETAILED DESCRIPTION

Attention is directed to FIG. 1, which provides a side perspective view of an embodiment for a planer apparatus 20, revealing some of the exemplary components which may be included in a useful planer apparatus 20, showing a stationary frame 22 which includes first and second wheels 24_{R} and 26_{R} (on the right side), and also mirror image third and fourth wheels 24_{L} and 26_{L} (not shown) on the left side, all for movement along a pair of spaced apart rails 28, 30 (see FIG. 11). Returning to FIG. 1, a pivoting planer frame 32 is pivotally mounted to the stationary frame 22. A planer cutter head 34 is rotatably mounted to the pivoting planer frame 32. An extensible frame adjustment cylinder 36 may be provided to adjust upward or downward, as indicated by reference arrows A, the vertical height of pivoting planer frame 32. When an extensible frame adjustment cylinder 36 is provided for use as the adjustable drive, it may be electrically actuated, or hydraulically actuated, as further described below.

As depicted in FIG. 26, for example, the pivoting planer frame 32 may be lowered downward from an uppermost position H_{O}, to an intermediate height H_{I}, or to a contact height where the planer cutter head 34 is at a height H_{C} to contact the top T of a wood workpiece W to be planed, or further to a level H_{O} which defines a depth of cut selected for working a particular wood workpiece W. Adjustment upward or downward as indicated by the reference arrows A can thus be made of the pivoting planar frame 32. The lowest height to which the planer cutter head 34 may be lowered may be defined by an end height H_{E}, which represents the end of extension of the pivoting planer frame 32 that is provided by a selected adjustable drive used with extensible frame adjustment cylinder 36. The overall range of extension height may be defined by a vertical adjustment range H_{R}, for any given design. In an embodiment, the vertical adjustment range H_{R} may be from more than zero (0) to about four (4) feet. In an embodiment, the vertical adjustment range H_{R} may be from more than zero (0) to about three (3) feet. In an embodiment, the vertical adjustment range H_{R} may be from more than zero (0) to about two (2) feet. A selected adjustment range may be incorporated in to a particular design to accommodate a desired manufacturing sequence as regards surface planing requirements and wood thickness requirements for a wood workpiece W, in order to plane a wood log slab to achieve the desired thickness and finish, as may be useful for a table, desk, bench, or the like.

As seen in FIG. 4, in an embodiment the stationary frame 22 may include a first base member 40 and a second base member 42. The first base member 40 and the second base member 42 are spaced apart, with each having a front end 40_{F}, 42_{F}, and a rear end 40_{R}, 42_{R}. In an embodiment, the stationary frame 22 may further include a first front post 44 (see FIG. 11) and a second front post 46. The first front post 44 and the second front post 46 each have a bottom 44_{B}, 46_{B}, and a top, 44_{T}, 46_{T}. The bottom 44_{B} of the first front post 44 may be affixed at or near the front end 40_{F} of the first base member 40, and extend upward therefrom. The bottom 46_{B} of the second front post 46 may be affixed at or near the front end 42_{F} of the second base member 42 and extend upward therefrom. As seen in FIGS. 4 and 5, a first rear post 54 and a second rear post 56 may be provided. The first rear post 54 and the second rear post 56 each have a bottom 54_{B}, 56_{B}, and a top, 54_{T}, 56_{T}. The bottom 54_{B} of the first rear post 54 may be affixed at or near the rear end 40_{R} of the first base member 40. The bottom 56_{B} of the second rear post 56 may be affixed at or near the rear end 42_{R} of the second base member 42.

As seen in FIGS. 5, 6, and 7, in an embodiment, a front cross bar 58 may be provided. The front cross bar 58 may be oriented orthogonally to the first base member 40 and to the second base member 42. In an embodiment, the front cross bar 58 may be secured to the first front post 44 and to the second front post 46. A first pivot mount 60 is affixed to the front cross bar 58. The first pivot mount 60 (see FIG. 7) may include a first pivot mount bracket 62 and a second pivot mount bracket 64. A first pivot pin 66 pivotally connects the first pivot mount 60 to the first longitudinal frame member 80 of the pivoting planer frame 32. As shown in FIG. 6, second pivot mount 68 is also provided, mounted to the front cross-bar 58, and spaced apart from the first pivot mount 60. The second pivot mount 68 may include a third pivot mount bracket 70 and a fourth pivot mount bracket 72. A second pivot pin 74 pivotally connects the second pivot mount 68 to the second longitudinal frame member 82 of the pivoting planer frame 32.

Turning now to FIGS. 1, 4, 5, and 6, an upper rear cross member 76 may be provided in stationary frame 22. In an embodiment, the upper rear cross member 76 may be oriented orthogonally to the first base member 40 and to the second base member 42. The upper rear cross member 76 may be secured to the first rear post 54 and to the second rear post 56, at or near their respective top, 54_{T}, 56_{T}. A lower rear cross member 78 may be provided to strengthen the stationary frame 22. The lower rear cross member 78 may be oriented orthogonally to the first base member 40 and to the second base member 42. The lower rear cross member 78 may be secured to and between the first rear post 54 and the second rear post 56.

A pivoting planer frame 32 is provided. The pivoting planer frame 32 may include a first longitudinal planer frame member 80 and a second longitudinal planer frame member 82. The first longitudinal planer frame member 80 and the second longitudinal planer frame 82 each have a front end 80_{F}, 82_{F} (see FIGS. 6 and 7) and a rear end 80_{R}, 82_{R} (see FIGS. 4 and 5). A first rear planer frame cross member 84 (see FIG. 4) may be mounted between the first longitudinal planer frame member 80 and the second longitudinal planer frame member 82, near the rear end 80_{R}, 82_{R}, of each. A second rear planer frame cross member 85 may be provided, spaced rearward of the first rear planer frame cross member 84.

As seen in FIG. 5, a front planer frame cross member 86 may be provided. A front planer frame cross member 86 may be mounted between the first longitudinal planer frame member 80 and the second longitudinal planer frame member 82, at, or near the front end 80_{F}, 82_{F}, of each.

As also seen in FIGS. 6 and 7, the first longitudinal planer frame member 80 may include a first pivot receiver 90 for receiving pivot pin 66. The second longitudinal planer frame member 82 may include a second pivot receiver 92 for receiving pivot pin 74. The first pivot receiver 90 and the second pivot receiver 92 are thus spaced apart and sized and shaped for cooperation with the pivot pins 66 and 74. In this manner, the pivoting planer frame 32 may be secured for pivotal movement with respect to the stationary frame 22.

In various embodiments, as seen in FIGS. 4 and 5, an adjustable drive may be provided to enable motion between the stationary frame 22 and the pivoting planer frame 32. Although the pivoting planer frame 32 moves arcuately about pivot pins 66 and 74, the motion at the distal end (see 80_{R}, at second rear planer frame cross member 85) is substantially vertical in nature, as shown in FIGS. 5 and 26. In an embodiment, an extensible frame adjustment cylinder 36 may be provided. The frame adjustment cylinder 36 may include a cylinder barrel 98 and an extensible piston 100. In an embodiment, the frame adjustment cylinder 36 is attached to upper rear cross member 76 via drive pivot mount 102, and to the first rear planer frame cross member 84 with lower pivot mount 104 at the distal end 106 of the extensible piston 100. As noted in FIGS. 5 and 26, in an embodiment, an electric motor drive 108 may be provided to enable fine adjustment of the depth of cut H_{D} in a wood workpiece W. In any event, the frame adjustment cylinder 36 is configured to effect precise movement between the upper rear cross member 76 and the first rear planer frame cross member 84, in order to adjust the depth of cut H_{D} as desired or required. In an embodiment, a depth of cut H_{D} in the one-eighth inch range, or more has been demonstrated. In an embodiment, a depth of cut H_{D} in the one-quarter inch range, or more has been demonstrated. In an embodiment, a depth of cut H_{D} in the one-half inch range, or more, has been demonstrated. In an embodiment, a depth of cut H_{D} in the three-quarter inch range, or more, has been demonstrated.

As seen in FIGS. 1, 5, 24, and 25, a planer cutter head 34 is provided. The planer cutter head 34 is rotatably mounted to the pivoting planer frame 32. As can be seen in FIG. 24, the height of the planer cutter head 34 above the top T of the wood workpiece W, or a depth of engagement (depth of cut H_{D}) with the wood workpiece W is adjustable by operation of the frame adjustment cylinder 36, so that the planer cutter head 34 may be adjustably engaged with or disengaged from the wood workpiece W. As seen in FIGS. 4 and 26, the planer cutter head 34 may be driven by a cutter head motor 110, which may be an electric motor operatively configured to drive the planer cutter head 34 by a motor pulley 112, the driven cutter pulley 114, and cutter drive belt 116 system which may be protected by safety cage 118 (see FIG. 8).

As seen in FIGS. 11, 12, and 13, a workpiece W such as a wood slab may be secured on a platen P between rails 28 and 30 by a plurality of workpiece clamps 120. In various embodiments, the platen P may be provided in the form of a smooth, leveled, wooden surface having a length P_{L}. Where appropriate, the platen P may be provided in multiple segments, such as by coupling multiple rail trailers together, when each trailer includes a platen P between rails 28 and 30, and wherein rails 28 and 30 may be fabricated from securely joined rail sections. In an embodiment, the wooden surface of the platen P may be a selected hardwood. In various embodiments, workpiece clamps 120 may be fabricated using an L-shaped angle iron having a horizontal portion 122 and an upright portion 124. The workpiece clamps 120 may be provided in steel and provided with a length of one (1) foot or more, or between about one (1) foot and about two (2) feet, wherein the L-shaped flange has a horizontal portion 122 and an upright portion 124. In an embodiment, a pair of nuts 126 and 128 may be provided, spaced apart and welded to the upright portion 124. Threaded bolts 130, sized and shaped for complementary threaded engagement with one of the nuts 126 or 128 are provided. In an embodiment a locking nut 126L or 128L may be provided on a threaded bolt 130, for securing the threaded bolt 130 in place. The threaded bolts 130 may each further include a distal end 132 (see FIG. 13A) wherein the distal end 132 may be generally conical in shape for indentation into and thus providing secure engagement with a wood workpiece W. As seen in FIG. 12, for secure positioning of the workpiece W, in an embodiment each of the workpiece clamps 120 may be secured to the wooden platen P using a plurality of wood screws 129 that pass through holes 133 (see FIG. 13) in the horizontal portion 122 and penetrate into the platen P.

The planer apparatus 20 may be moved along rails 28 and 30 by wheels adapted for rolling on rails, such as depicted in FIGS. 1, 4, 5, and 26. FIG. 5, being a vertical diagrammatic view, shows the location of a first wheel 24_{L} and a second wheel 26_{L}, both located on the left side, when oriented toward the direction of movement during planing operations, as represented by reference arrow M. Thus the first wheel 24_{L} and second wheel 26_{L} are located at or adjacent the bottom 40_{B} of the first base member 40. In an embodiment, the first wheel 24_{L} may be located near the front end 40_{F} of the first base member 40, and the second wheel 26_{L} may be located near the rear end 40_{R} of the first base member 40. Similarly, both third wheel 24_{R} and fourth wheel 26_{R}, are located on the right side (see FIG. 1). Thus the third wheel 24_{R} and fourth wheel 26_{R} are located at or adjacent the bottom 42_{B} of the second base member 42. In an embodiment, the third wheel 24_{R} may be located near the front end 42_{F} of the second base member 42, and the fourth wheel 26_{R} may be located near the rear end 42_{R} of the second base member 42. Each of the first 24_{L} second 26_{L}, third 24_{R} and fourth 26_{R} wheels are sized and shaped for rolling engagement with one of parallel support rails 28 and 30.

As seen in FIG. 30, a chain drive motor 140 may be operatively connected to, and is configured to power at least one, or in an embodiment, at least two, or in an embodiment, more than two, or in an embodiment, all of the first 24_{L} second 26_{L}, third 24_{R} and fourth 26_{R} wheels. Thus, the planer apparatus 20 is movable substantially horizontally along the parallel support rails 28 and 30, so that it thereby engages a wood workpiece W affixed by the plurality of workpiece clamps 120 at a stationary position between the parallel support rails 28 and 30. In an embodiment, the chain drive motor 140 may be an electric motor 142, wherein a gear drive 144 is coupled to the electric motor 142. The gear drive 144 may be coupled to a drive shaft 145 (see FIG. 30) which is operatively connected with a first drive chain 146_{L} on the left side, and a second drive chain 146_{R} on the right side. In an embodiment, the first drive chain 146_{L} may be operatively coupled to the first wheel 24_{L} and the second drive chain 146_{R} may be operatively coupled to the third wheel 24_{R}. In an embodiment, the first drive chain 146_{L} may be operatively coupled to the first wheel 24_{L} and to the second wheel 26_{L}. In an embodiment, the second drive chain 146_{R} may be operatively coupled to the third wheel 24_{R} and to the fourth wheel 26_{R}. Coupling of the drive shaft 145 to selected wheels (24_{L}, 24_{R}, 26_{L}, 26_{R}, as noted above) may be via gear sprockets 148 (see FIG. 28) that are sized and shaped for operative interaction with the first drive chain 146_{L} and on the other side, with second drive chain 146_{R}.

As seen in FIG. 14, in an embodiment, a trailer 150 with parallel support rails 28 and 30 may be provided for transport of the planer 20. In an embodiment, the trailer 150 may be sized, shaped, and configured with a load bearing capacity adequate for over-the-road carriage of the planer apparatus 20.

Attention is now drawn to a few additional design details that may be useful in a robust planer apparatus 20 configuration. As seen in FIG. 4, the upper rear cross member 76 includes a center portion 76c, at which the drive pivot mount 102 is provided for pivotally affixing the frame adjustment cylinder 36 to the center portion 76c of the upper rear cross member 76, In this manner, the loading on the pivoting planer frame 32 is distributed equally when the frame adjustment cylinder 36 is used to apply pressure against a wood workpiece W, and thus achieve a uniform depth of cut H_{D} by the planner apparatus 20. Additionally, the lower rear cross member 84 includes a central portion 84c, where a distal end 106 of the extensible piston 100 of frame adjustment cylinder 36 is mounted via lower pivot mount 104 (also see FIG. 5) to the central portion 84c of the lower rear cross member 84. In an embodiment, the frame adjustment cylinder 36 may be powered using an electric motor 160, and thus the frame adjustment cylinder 36 may be an electrically driven cylinder.

As mentioned above, the planer cutter head 34 may be provided with and operatively powered by a cutter head motor 110. In an embodiment, the cutter head motor 110 may be an electric motor. In an embodiment, the planer cutter head motor 110 may be provided with motor pulley 112, and the planer cutter head 34 may be provided with a driven cutter pulley 114, cutter drive belt 116 is used to provide power from the cutter head motor 110 to the planer cutter head 34. A safety cage 118 may be provided to prevent inadvertent access to the motor pulley 112, the driven cutter pulley 114, and the cutter drive belt 116.

In an embodiment, the planer cutter head 34 comprises a substantially cylindrical roller. In an embodiment, the operative cutting width C of the planer cutter head 34 (see FIG. 11) may be in the range of from three (3) to four (4) feet. In an embodiment, the operative cutting width C may be in the range of from four (4) to five (5) feet. In an embodiment, the operative cutting width C may be in the range of from about five (5) to about eight (8) feet.

Attention is now drawn to FIG. 9 which provides a top perspective view, looking down from the left rear, looking forward at a first positioning roller 200 secured by roller mount 202 for adjustable rolling engagement with first rear post 54, and is used for maintaining a firm spaced relationship between first longitudinal planer frame member 80 of the pivoting planer frame member 32, and an interior surface 54_{S} of the first rear post 54 of the stationary frame 22. A mirror image roller system (not shown shown) provides a second positioning roller 201 secured by a roller mount 202 for adjustable rolling engagement between an interior surface 56_{S} of the second rear post 56 of the second longitudinal planer frame 82 of the pivoting planer frame 32. A pivot pin 203 and pivoting mount 204 for the cutter head motor 110 is seen in FIG. 7.

As can be appreciated from FIGS. 1, 4, and 27, in an embodiment, the control panel 190 may be pivotally mounted to the stationary frame 22. In such an embodiment, the control panel 190 may be secured by spring loaded pin 192 (see FIG. 27), which releases the control panel swing arm 194 by upward motion in the direction of reference arrow 196 (see FIG. 27), so that the control panel 190 may be moved outward in the direction of reference arrow 198, wherein an operator may use the control panel 190 while observing the planing operation in progress below. Additionally, control and instrument box 199 for with control knob 216 for controlling downward pressure on the leading roller 220 and control knob 218 for controlling downward pressure on the trailing roller 222 (as further described below) may also be located on control panel swing arm 194. In an embodiment, the planer apparatus 20 is sized and shaped for planing operation on a wood workpiece W where the wood workpiece W is a wood log slab.

As additionally seen in FIG. 26, and as can be appreciated by reference to FIGS. 4 and 5, the apparatus 20 may be configured for operation on parallel rails 28 and 30. In an embodiment, as may be noted in FIG. 26, the parallel rails 28 and 30 may be provided in a length to enable the planer apparatus 20 to traverse distance D. In an embodiment, distance D may be between twenty (20) feet and twenty five (25) feet. In an embodiment, distance D may be between twenty (20) feet and thirty (30) feet. In an embodiment, distance D may be greater than thirty (30) feet.

Returning to FIGS. 1, 2, 11, 12, 25, and 26, in order to provide a relatively clean working environment for use of the planer apparatus 20, a sawdust and chip collection system 170 may be provided. First, as seen in FIG. 25, adjacent the planer cutter head 34, a chip capture blade 240 is provided. A chip capture blade support 242, on which the chip capture blade 240 may be mounted for use by using suitable fasteners 244, is shown. The chip capture blade 240 is configured for contact with the top T of a workpiece W, and thus is prone to wear, and thus as a wear part it will eventually require replacement. During use, the chip capture blade 240 receives an exhaust air stream containing sawdust and chips from the cutter head 34 and captures the same for entry into the sawdust and chip collection system 170. When necessary, a new chip capture blade 240 may be provided and mounted on blade support 242, after usage of the adjustable planer 20 results in end-of-life wear on the chip capture blade 240. Additionally, a blade adjustment mechanism 250 is provided, which may be in the form of a pivotable lever 252 connected to the chip capture blade 240, with a contact tab 256 on the distal end 258 of the pivotable lever 252. The contact tab 256 may be moved via adjustment screw 259, threadably mounted on fixed tab 260, in order to provide for setup and adjustment of the angle the chip capture blade 240, so that it can be suitably positioned against the top T of a selected workpiece W.

As may be better appreciated from review of FIGS. 2, 5, 6, 24, 25, and 26, a chip collection system 170 may be provided. The chip collection system may include one or more inlets 172 adjacent the chip capture blade 240. One or more inlet plenums 173 (e.g. see FIG. 24, 173_{A} and 173_{B}) one or more intake ducts 174 (e.g. 174_{A} and 174_{B}), one or more cyclone separators 176 (i.e. 176_{A} and 176_{B}), may be provided to separate sawdust 171 and chips 181. In an embodiment, a chip outlet 176o of the cyclone separators 176 discharges chips 181 into a screw conveyor 177, which in an embodiment may be a horizontal screw conveyor. As seen in FIG. 27, chips 181 which accumulate in the screw conveyor 177 are discharged at an outlet 184 via a rotary airlock 179. The captured chips 181 may be emptied into a catch basket 183.

As seen in FIGS. 1, 2, and 5, the sawdust 171 from cyclone separators 176 may be combined at collector 175 into a single sawdust plenum 168, and routed to a chip collection exhaust blower 178. As seen in FIG. 11, exhaust from the chip collection exhaust blower 178 travels via outlet duct 188 into a baghouse 182. The blower motor 180 for the chip collection exhaust blower 178 may be mounted on a stand 185. As seen in FIG. 11, baghouse 182 may include support straps 191 held in place by detachable frame 193. When the baghouse 182 is full of sawdust 171, it may be emptied by removing the detachable frame 193 from frame mount 195, and detached from outlet duct 188, as seen in FIG. 12.

As better seen in FIGS. 5, 13, and 15, the leading roller 220 is mounted to leading roller pivoting frame 300 having lead suspension legs 300_{L} and 300_{R}, for rolling action, pressing down into a workpiece W. The leading roller pivoting frame 300 is pivotally affixed at first pivot 302 and second pivot 303 to a cross-member 304. The leading roller pivoting frame 300 includes left 300_{L} and right 300_{R} lead roller suspension leg members, which extend from a hip end 305 to a knee 306 and thence downward to a distal end 308, at which the leading roller 220 is attached. A leading roller frame cross-member 310 is affixed between the left 300_{L} and right 300_{R} lead roller suspension leg members, at location between their respective hip end 305 and the knee 306 portions. At the center of the cross-member 310 a mount 312 is provided for pivotally mounting a lead actuator 314 thereto for moving the leading roller pivoting frame 300 up or down. A generally upside down U shaped cross-member 320 is mounted between longitudinal members 80 and 82, at a location above cross-member 310. On either side of lead actuator 314, a plurality of lead airbags, shown as lead airbag 324 and lead airbag 326, are mounted between cross-member 310 and upside down U shaped cross-member 320. The lead actuator 314 moves the lead suspension legs 300_{L} and 300_{R} supporting the leading roller 220 up or down. When the leading roller 220 is in operating position, the lead airbags 324 and 326 cooperate to provide uniform spanwise pressure downward against workpiece W, via leading roller 220. The support structure just described for the leading roller 220 provides positions the leading roller where airbags, shown as mounted for operation, may be adjustably inflated or deflated to control downward pressure on the leading roller 220, so that the leading roller 220 can apply pressure on a workpiece W to secure the workpiece W slab in place while being worked. The supply of compressed air for airbag operation is unremarkable and may be provided by those of skill in the art without need for further elaboration.

Various aspects of the structure and operation of the trailing roller 222 are shown in FIGS. 18 through 23 and described below. In FIG. 18, a perspective view of the trailing roller 222 is shown, mounted adjacent the rotary cutter head 34. A first rear planer frame cross-member 84 and second rear planer frame cross-member 85 are provided between first longitudinal planer frame member 80 and a second longitudinal planer frame member 82. A left trail suspension arm 350_{L} and a right trail suspension arm 350_{R} are each pivotally mounted to the second rear planer frame cross member 85. In an embodiment, the left trail suspension arm 350_{L} is secured to second rear planer frame cross member 85 at pivot 352, as seen in FIG. 22. In an embodiment, the right trail suspension arm 350_{R} is secured to the second rear planer frame cross-member 85 at pivot 354, as seen in FIG. 21. In various embodiments, left trail suspension arm 350_{L} and a right trail suspension arm 350_{R} may each be provided as downwardly disposed L-shaped arms, each which extends to a distal end 350_{DL} and 350_{DR}, respectively, between which the trailing roller 222 is mounted for rolling motion across the top of a workpiece W, while applying pressure downward against an upward face of the workpiece W. In an embodiment, a trailing roller cross-arm 358 is provided, as seen in FIG. 23. The trailing roller cross-arm 358 is secured to and disposed between the left trail suspension arm 350_{L} and the right trail suspension arm 350_{R}

The mounting details of a plurality of airbags, shown as trail airbag 360 and trail airbag 362, which are used for controlling pressure of the trailing roller 222 against an upward face of workpiece W are shown in FIGS. 18,19, and 20. A trail pivot lower mount 363 is provided at the center of trailing roller cross-arm 358 for pivotably mounting a trail actuator 364 with trail piston 366 which is used for downward extension and upward retraction of the trailing roller 222, by movement of trail piston 366 against trail pivot upper mount 365 located on cross-bar 367.

The frame adjustment cylinder 36, which may be centrally mounted, provides the force needed to move the pivoting planer frame 32, upward or downward. Once the trailing roller 222 is in an operating position, trail airbags 360 and 362 may adjustably apply pressure to a workpiece W to secure a workpiece W slab in place during planing operation. The moving piston 366 of the trail actuator 364 is shown pivotably mounted to a cross-bar 367 in FIG. 19.

FIG. 20 is similar to FIG. 18 but more clearly shows the mounting configuration for the top of the airbags 372 used for distributing downward pressure across the trailing roller 222. In each case, an upper longitudinal member, 374 and 376, is secured between cross-members, and the trail airbags 370 and trail airbag 372 are attached, at their respective centers, to the adjacent longitudinal member 274 or 376. The trailing roller 222 is adjustable via application of pneumatic pressure to using trail airbags 370 and 372, to force the trailing roller 222 downward toward a workpiece W, whereby substantially uniform pressure is applied across the trailing roller 222.

Attention is directed to FIGS. 28, 29 and 30. FIG. 30 provides a partial perspective view of selected portions of the interior of the front of an embodiment of a planer apparatus 20. A drive shaft 145 is used to transmit rotating force from the chain drive motor 140 via the chain gear box 144 to the chain drive apparatus on the side opposite the chain drive motor 140.

Finally, attention is directed to FIGS. 1, 4, and 5, where a weight box 380 is provided. The weight box is a convenient receptacle for weights, such as large lead weights, which may be placed in the weight box 380 to even the loading on planer apparatus 20. This has been found to be useful to carefully even the top surface T of a finished workpiece W, since, due to high weight of the cutter head motor 110 that drives the rotary cutter head 34, more pressure may be applied on the cutter head motor 110 side of the apparatus 20, than on the other side. Thus, by placing the weight box 280 directly opposite the cutter head motor 110 location, a uniform planing operation, and a true even planed workpiece, can be provided.

It is to be appreciated that the planer apparatus 20 described herein is an appreciable improvement in the art of planers for the planing of “live edge” type log slabs. Importantly, the use of the planer apparatus 20 disclosed herein will reduce the amount of manual work, or manually manipulated sanding or other finishing work using portable tools.

Although only a few exemplary embodiments have been described in detail, various details are sufficiently set forth in the drawings and in the specification provided herein to enable one of ordinary skill in the art to make and use the invention(s), which need not be further described by additional writing in this detailed description. It will be readily apparent to those skilled in the art that the planer apparatus 20 described herein, and especially in view of its mass and rigidity given the strong a and heavy structure thereof, may be modified from those embodiments provided herein, without materially departing from the novel teachings and advantages provided.

Thus, it is to be understood that the various aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures.

Numerous modifications and variations are possible in light of the above teachings. It is therefore to be understood that within the scope of the appended claims, the invention(s) may be practiced otherwise than as specifically described herein. Thus, the scope of the invention(s), as set forth in the appended claims, and as indicated by the drawing and by the foregoing description, is intended to include variations from the embodiments provided which are nevertheless described by the broad interpretation and range properly afforded to the plain meaning of the claims set forth below.

1. A planer apparatus for plaining a face of a wood workpiece, comprising:
(a) a stationary frame, the stationary frame having
a first base member and a second base member, the first base member and the second base member spaced apart and each having a front end and a rear end,
a first front post and a second front post, the first front post and the second front post each having a bottom and a top, the bottom of the first front post affixed at or near the front end of the first base member and extending upward therefrom, and the bottom of the second front post affixed at or near the front end of the second base member and extending upward therefrom,
a first rear post and a second rear post, the first rear post and the second rear post each having a bottom and a top, the bottom of the first rear post affixed at or near the rear end of the first base member, and the bottom of the second rear post affixed at or near the rear end of the second base member,
a front cross bar, the front cross bar oriented orthogonally to the first base member and to the second base member, wherein the front cross bar is secured to the first front post and to the second front post,
a first pivot mount and a second pivot mount, the first and second pivot mounts spaced apart and each affixed to the front cross bar, and each further comprising a pivot pin,
an upper rear cross member, the upper rear cross member oriented orthogonally to the first base member and to the second base member, the upper rear cross member secured to the first rear post and to the second rear post, at or near their respective top,
a lower rear cross member, the lower rear cross member oriented orthogonally to the first base member and to the second base member, the lower rear cross member secured to and between the first rear post and the second rear post,
(b) a pivoting planer frame, the pivoting planer frame having
a first longitudinal planer frame member and a second longitudinal planer frame member, the first longitudinal planer frame member and the second longitudinal planer frame each having a front end and a rear end,
a rear planer frame cross member, the rear planer frame cross member mounted between the first longitudinal planer frame member and the second longitudinal planer frame member, and at or near the rear end of each,
a front planer frame cross member, the front planer frame cross member mounted between the first longitudinal planer frame member and the second longitudinal planer frame member, at or near the front end of each of the first and second longitudinal planer frame members,
a first pivot receiver and a second pivot receiver, the first pivot receiver located at the front end of the first longitudinal planer frame member, and the second pivot receiver located at the front end of the second longitudinal planer frame member, the first and second pivot receivers sized and shaped for pivoting engagement with the pivot pins disposed from the first pivot mount and from the second pivot mount, whereby the pivoting planer frame is secured for pivotal movement with respect to the stationary frame,
(c) an adjustable frame cylinder, the adjustable frame cylinder comprising a mount, a cylinder barrel, and an adjustable piston, the adjustable piston having a distal end, the adjustable frame cylinder operably secured between the upper rear cross member and the rear planer frame cross member, wherein the adjustable frame cylinder is configured to effect movement there between; and
(d) a planer cutter head, the planer cutter head rotatably mounted to the pivoting planer frame, wherein a height of the planer cutter head above the wood workpiece, or a depth of engagement with the wood workpiece, is adjustable by operation of the adjustable frame cylinder, and whereby the planer cutter head may be adjustably engaged with, or disengaged from, a wood workpiece.

2. A planer apparatus as claimed in claim 1, further comprising a plurality of lead airbags and a leading roller, the leading roller affixed for rotation on lead suspension arms, the lead suspension arms pivotally connected to and extending from the pivoting frame member, the leading roller adjustable via application of pneumatic pressure to force the leading roller downward toward a workpiece whereby substantially uniform pressure is applied across the leading roller.

3. A planer apparatus as claimed in claim 2, further comprising a plurality of trail airbags and a trailing roller, the trailing roller affixed for rotation to trail suspension arms, and pivotally connected to and extending from the pivoting frame member, the trailing roller adjustable via application of pneumatic pressure to force the trailing roller downward toward a workpiece, whereby substantially uniform pressure is applied across the trailing roller.

4. A planer apparatus as claimed in claim 1, further comprising a pair of spaced apart parallel support rails, the rails sized and shaped to support movement of the planer apparatus thereon.

5. A planer apparatus as claimed in claim 4, further comprising:
a first wheel and a second wheel, each rotatably mounted at or adjacent the bottom of the first base member of the stationary frame, the first wheel located near the front end of the first base member, and the second wheel located near the rear end of the first base member;
a third wheel and a fourth wheel, each rotatably mounted at or adjacent the bottom of the second base member of the stationary frame, the third wheel located near the front end of the first base member, and the fourth wheel located near the rear end of the second base member; and
a drive, the drive operatively connected to the first, second, third, and fourth wheels, and wherein each of the first, second, third, and fourth wheels are sized and shaped for rolling engagement with one of the parallel support rails, so that the planer apparatus is movable substantially horizontally along the parallel support rails, so that it thereby engages a wood workpiece affixed at a stationary position between the parallel support rails.

6. A planer apparatus as set forth in claim 5, wherein the drive comprises an electric motor, a gear drive coupled to the electric motor, a drive shaft coupled to the gear drive, and a first drive chain, and a second drive chain operatively coupled to the drive shaft, and wherein the first drive chain is operatively coupled to the first wheel and to the second wheel, and wherein the second drive chain is operatively coupled to the third wheel and to the fourth wheel.

7. A planer apparatus as set forth in claim 5, further comprising a trailer, and wherein the parallel support rails are sized and shaped for support of the planer are mounted on the trailer.

8. A planer apparatus as set forth in claim 1, wherein the upper rear cross member includes a center portion, and wherein a mount for the adjustable frame cylinder is pivotally affixed to the center portion of the upper rear cross member.

9. A planer apparatus as set forth in claim 8, wherein the lower rear cross member includes a central portion, and wherein a distal end of the adjustable piston is pivotally mounted to the central portion of the lower rear cross member.

10. A planer apparatus as set forth in claim 9, wherein the adjustable frame cylinder comprises an electric drive cylinder.

11. A planer apparatus as set forth in claim 1, further comprising a planer cutter head motor, and wherein the planer cutter head is operatively powered by the planer cutter head motor.

12. A planer apparatus as set forth in claim 11, wherein the planer cutter head motor comprises an electric motor.

13. A planer apparatus as set forth in claim 12, further comprising a motor pulley, a cutter pulley, and a cutter drive belt, and wherein the cutter drive belt is configured to drive the planer cutter head.

14. A planer apparatus as set forth in claim 13, further comprising a safety cage disposed over the motor pulley, the cutter pulley, and cutter drive belt.

15. A planer apparatus as set forth in claim 1, wherein the planer cutter head comprises a roller, and wherein the roller has an operative cutting width of at least four (4) feet.

16. A planer apparatus as set forth in claim 1, further comprising a chip collection system, the chip collection system comprising one or more intake ducts, a separator, an exhaust fan, and chip collecting screw conveyor.

17. A planer apparatus as set forth in claim 16, further comprising a rotary airlock, the rotary airlock affixed at an outlet of the screw conveyor, whereby chips collected in the screw conveyor are discharged through the rotary airlock.

18. A planer apparatus as set forth in claim 1, wherein the planer apparatus is sized and shaped for planing operation on a wood workpiece, wherein the wood workpiece comprises a wood slab.

19. A planer apparatus as set forth in claim 1, further comprising a control panel, and wherein the control panel is pivotally mounted to the stationary frame.

20. A planer apparatus as claimed in claim 1, further comprising a plurality of workpiece clamps.

21. A planer apparatus as claimed in claim 5, further comprising a plurality of workpiece clamps, wherein each of the workpiece clamps comprises (a) an L-shaped flange, the L-shaped flange having a length of at least one (1) foot, a horizontal portion, and an upright portion, (b) a pair of nuts spaced apart and welded to the upright portion, and (c) a pair of threaded bolts, the threaded bolts each sized and shaped for complementary threaded engagement with one of the pair of nuts, the threaded bolts each having a distal end, and wherein the distal end comprises a conical shape, to thereby provide secure engagement with a wood workpiece.

22. A planer apparatus for planing a face of a wood workpiece, comprising:
(a) a stationary frame, the stationary frame comprising
a first base member having a front end and a rear end and a second base member having a front end and a rear end,
a front cross bar, the front cross bar oriented orthogonally to the first base member and to the second base member and operatively coupled thereto,
a first pivot mount and a second pivot mount, the first and second pivot mounts spaced apart and each affixed to the front cross bar,
a first pivot pin operatively attached to the first pivot mount,
a second pivot pin operatively attached to the second pivot mount,
a first rear post extending upward from the rear end of the first base member,
a second rear post extending upward from the rear end of the second base member,
an upper rear cross member, the upper rear cross member oriented orthogonally to the first base member and to the second base member, the upper rear cross member secured to the first rear post and to the second rear post, at or near their respective top;
(b) a pivoting planer frame, the pivoting planer frame having
a first longitudinal planer frame member and a second longitudinal planer frame member, the first longitudinal planer frame member and the second longitudinal planer frame each having a front end and a rear end,
a rear planer frame cross member, the rear planer frame cross member mounted between the first longitudinal planer frame member and the second longitudinal planer frame member, and at or near the rear end of each,
a first pivot receiver and a second pivot receiver, the first located at the front end of the first longitudinal planer member, and second pivot receiver located at the front end of the second longitudinal planer member, the first pivot receiver sized and shaped for pivoting attachment to the first pivot pin, and the second pivot receiver sized and shaped for pivoting attachment to the second pivot pin;
(c) an adjustable frame cylinder, the adjustable frame cylinder operably secured between the upper rear cross member and the rear planer frame cross member, wherein the adjustable frame member is configured to effect movement therebetween; and
(d) a planer cutter head, the planer cutter head rotatably mounted to the pivoting planer frame, wherein a height of the planer cutter head above the wood workpiece, or a depth of engagement with the wood workpiece, is adjustable by operation of the adjustable frame cylinder, and whereby the planer cutter head may be adjustably engaged with, or disengaged from, the wood workpiece.

23. A planer apparatus as claimed in claim 22, wherein the adjustable frame cylinder comprises a drive cylinder, and wherein the drive cylinder comprises a mount, a cylinder barrel, and an adjustable piston, the adjustable piston having a distal end, and wherein the adjustable frame cylinder is pivotally mounted at the upper rear cross member and at the rear planer frame cross member.

24. A planer apparatus as claimed in claim 22, further comprising a pair of spaced apart parallel support rails.

25. A planer apparatus as set forth in claim 24, further comprising a trailer, and wherein the parallel support rails are mounted on the trailer.

26. A planer apparatus as set forth in claim 22, further comprising a roller positioning system, the roller positioning system comprising a first roller mount and a first roller, and a second roller mount and a second roller, the first roller mounted for secure rolling engagement between the first rear post and a first longitudinal planar member, and the second roller mounted for secure rolling engagement between the second rear post and a second longitudinal planer member.

27. A planer apparatus as claimed in claim 22, further comprising:
a first wheel and a second wheel, each rotatably mounted to the first base member of the stationary frame, the first wheel located near the front end of the first base member, and the second wheel located near the rear end of the first base member;
a third wheel and a fourth wheel, each rotatably mounted to the second base member of the stationary frame, the third wheel located near the front end of the first base member, and the fourth wheel located near the rear end of the second base member; and
a drive, the drive operatively connected to at least two of the first, second, third, and fourth wheels, and wherein each of the first, second, third, and fourth wheels are sized and shaped for rolling engagement with one of parallel support rails, so that the planer apparatus is movable substantially horizontally along the parallel support rails.

28. A planer apparatus as set forth in claim 27, wherein the drive comprises an electric motor, a gear drive coupled to (a) the electric motor and (b) to a first drive chain, and (c) to a second drive chain, and wherein the first drive chain is operatively coupled to at least one of the first wheel and the second wheel, and wherein the second drive chain is operatively coupled to at least one of the third wheel and the fourth wheel.

29. A planer apparatus as set forth in claim 27, wherein the drive comprises an electric motor, a gear drive coupled to (a) the electric motor and (b) to a first drive chain, and (c) to a second drive chain, and wherein the first drive chain is operatively coupled to the first wheel and the second wheel, and wherein the second drive chain is operatively coupled to the third wheel and the fourth wheel.

30. A planer apparatus as set forth in claim 1, or in 22, further comprising a sawdust and chip collection system, wherein the sawdust and chip collection system comprises a chip collection blade mount and a chip collection blade, wherein the chip collection blade comprises a replaceable wear part, and wherein the chip collection blade is detachably affixable to the chip collection blade mount.

31. A planer apparatus as set forth in claim 1, or in claim 22, further comprising a sawdust and chip collection system, wherein the sawdust and chip collection system further comprises an exhaust flower, and at least one cyclone separator, and wherein the at least one cyclone separator substantially removes chips from an exhaust stream containing sawdust and chips.

32. A planer apparatus as set forth in claim 31, further comprising a screw conveyor, and wherein chips separated by the at least one cyclone separator are discharged into the screw conveyor.

33. A planer apparatus as set forth in claim 32, further comprising a rotary airlock, and wherein chips accumulated in the screw conveyor are discharged outward through the rotary airlock.

34. A planer apparatus as set forth in claim 31, further comprising a baghouse, and wherein a sawdust stream from the cyclone separator is discharged into the baghouse.
